(19) United States
(12) Patent Application Publication
(10) Pub. No.: US 2021/0124914 A1
(43) Pub. Date: Apr. 29, 2021

(54) TRAINING METHOD OF NETWORK, MONITORING METHOD, SYSTEM, STORAGE MEDIUM AND COMPUTER DEVICE

(71) Applicant: JOMOO KITCHEN & BATH CO., LTD, Nan'an City (CN)

(72) Inventors: Xiaofa LIN, Nan'an City (CN); Xiaoshan LIN, Nan'an City (CN); Jinyu HU, Nan'an City (CN); Haifeng YU, Nan'an City (CN); Junqi LIANG, Nan'an City (CN)

(73) Assignee: JOMOO KITCHEN & BATH CO., LTD, Nan'an City (CN)

(21) Appl. No.: 16/704,304

(22) Filed: Dec. 5, 2019

(30) Foreign Application Priority Data
Oct. 28, 2019 (CN) 201911034172.X

(51) Int. Cl. G06K 9/00; G06K 9/62; G06N 3/08; G06N 3/04

(52) U.S. Cl. CPC G06K 9/00335; G06N 3/04; G06N 3/08; G06K 9/623

(57) ABSTRACT

Provided are a training method of a deep convolutional neural network, an abnormal behavior monitoring method and system, a storage medium and computer device. The deep convolutional neural network is a single-stage dual-branch convolutional neural network, and includes a first branch for predicting confidences and a second branch for predicting part affinity vector fields. The method includes: inputting an image to be identified; according to one or more preset objects to be identified, performing feature analysis on the image to be identified to obtain one or more feature map sets for the one or more objects to be identified in the image to be identified, wherein each feature map set corresponds to one object to be identified; inputting a feature map set into the first branch to obtain confidence prediction results; inputting the confidence prediction results and feature map set into the second branch to obtain affinity field prediction results.

### CROSS-REFERENCE TO RELATED APPLICATIONS

This application claims foreign priority benefits under 35 U.S.C. § 119(a)-(d) to Chinese Patent Application No. 201911034172.X, filed on Oct. 28, 2019, which is hereby incorporated by reference herein in its entirety for all purposes.

### TECHNICAL FIELD

Embodiments of the present disclosure relate to the computer field, in particular to a training method of a deep convolutional neural network, an abnormal behavior monitoring method and system, a storage medium and a computer device.

### BACKGROUND

A traditional monitoring system needs the guard of employed full-time on-duty personnel. The on-duty personnel needs to watch the monitoring pictures all the time, but for a large quantity of monitoring pictures, the on-duty personnel cannot see all the monitoring pictures. Therefore, most of the time, the traditional monitoring system is usually for the purpose of deterrence and post-event evidence-gathering.

### SUMMARY

Embodiments of the present application provide a training method of a convolutional neural network, an abnormal behavior monitoring method, an abnormal behavior monitoring system, a storage medium and a computer device.

In one aspect, an embodiment of the present disclosure provides a training method of a deep convolutional neural network. The deep convolutional neural network is a single-stage dual-branch convolutional neural network and includes a first branch for predicting confidences and a second branch for predicting part affinity vector fields. The method includes: inputting an image to be identified; according to a preset object to be identified, performing feature analysis on the image to be identified to obtain one or more feature map sets containing the object to be identified in the image to be identified, wherein each feature map set corresponds to one object to be identified; inputting one feature map set into the first branch of the deep convolutional neural network to obtain confidence prediction results; inputting the confidence prediction results and the one feature map set into the second branch of the deep convolutional neural network to obtain affinity field prediction results; and according to the confidence prediction results and the affinity field prediction results, obtaining a human body skeleton map.

In another aspect, an embodiment of the present disclosure provides an abnormal behavior monitoring method based on a deep convolutional neural network. The deep convolutional neural network is the deep convolutional neural network obtained by training according to the above method. The monitoring method includes: acquiring an image to be identified; acquiring a human body skeleton map for the image to be identified by using the deep convolutional neural network; and performing a behavior identification on the skeleton map, and triggering an alarm when an abnormal behavior is determined.

In yet another aspect, an embodiment of the present disclosure also provides an abnormal behavior monitoring system based on a deep convolutional neural network. The deep convolutional neural network is the deep convolutional neural network obtained by training in the aforementioned method. The system includes: an image capturing apparatus, configured to capture an image to be identified; a server end, configured to acquire the image to be identified sent by the image capturing apparatus, acquire a human body skeleton map for the image to be identified by using a deep convolutional neural network, and perform a behavior identification on the skeleton map, and send an alarm signal to a client when an abnormal behavior is determined; and the client, configured to receive the alarm signal sent by the server end and trigger an alarm according to the alarm signal.

In still another aspect, an embodiment of the present disclosure also provides a computer-readable storage medium on which program instructions are stored. The aforementioned method can be implemented when the program instructions are executed.

In still another aspect, an embodiment of the present disclosure also provides a computer device, which includes a memory, a processor and a computer program stored on the memory and executable by the processor, wherein the processor implements the acts of the aforementioned method when executing the program.

Additional features and advantages of the present application will be set forth in the following specification, and in part become apparent from the specification, or be learned by practice of the present application. Other advantages of the present application can be realized and obtained through solutions described in the specification, claims and drawings.

### BRIEF DESCRIPTION OF THE DRAWINGS

Accompanying drawings are used to facilitate understanding of technical solutions of the present application and form a part of the specification. Together with embodiments of the present application, accompanying drawings are used to explain technical solutions of the present application and do not constitute a limitation on technical solutions of the present application.

FIG. 1 is a schematic diagram of a 14-point skeleton map labeling approach according to an embodiment of the present disclosure.

FIG. 2 is a flow chart of a method according to embodiment one of the present disclosure.

FIG. 3 is a schematic diagram of structure of a single-stage dual-branch CNN network according to an embodiment of the present disclosure.

FIG. 4 is a flow chart of extracting skeleton maps of multiple persons according to an embodiment of the present disclosure.

FIGS. 5a-c are schematic diagrams of a process of connecting key points into a skeleton map according to an embodiment of the present disclosure.

FIG. 6 is a flow chart of an abnormal behavior monitoring method according to an embodiment of the present disclosure.

FIGS. 7a-d are schematic diagrams of abnormal behaviors on a balcony according to an embodiment of the present disclosure.

FIG. 8 is a schematic diagram of deployment of a monitoring system applied to a balcony scenario according to an embodiment of the present disclosure.

FIG. 9 is a schematic diagram of structure of a computer device according to an embodiment of the present disclosure.

### DETAILED DESCRIPTION

The required, detailed embodiments of the present disclosure are disclosed herein. However, it is to be understood that the disclosed embodiments are merely exemplary of the disclosure that may be embodied in various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

The present application describes multiple embodiments, but this description is exemplary rather than limiting, and it is apparent to those of ordinary skill in the art that there may be more embodiments and implementations within the scope of embodiments described in the present application. Although many possible combinations of features are shown in the drawings and discussed in the detailed description, many other combinations of the disclosed features are possible. Unless specifically limited, any feature or element of any embodiment may be used in combination with any other feature or element in any other embodiment, or may replace any other feature or element in any other embodiment.

The present application includes and envisages combinations of features and elements known by those of ordinary skill in the art. Embodiments, features and elements already disclosed in the present application may be combined with any conventional feature or element to form a unique inventive solution defined by the claims. Any feature or element of any embodiment may be combined with a feature or an element from another inventive solution to form another unique inventive solution defined by the claims. Therefore, it should be understood that any of the features shown and/or discussed in the present application may be implemented separately or in any suitable combination. Thus, embodiments are not restricted by limitations other than those defined by the appended claims and their equivalents, in addition, various modifications and changes can be made within the scope of protection of the appended claims.

Furthermore, when exemplary embodiments are described, the specification may have presented methods and/or processes as a specific order of acts. However, when the method or the process does not depend on a specific order of acts described herein, the method or the process should not be limited to the acts in the specific order. As one of ordinary skill in the art will understand, other orders of acts are possible. Therefore, the specific order of the acts set forth in the specification should not be interpreted as a limitation to the claims. Furthermore, the claims for the method and/or the process should not be limited to performing their acts in the written order, and those skilled in the art can readily understand that these orders may vary and still remain within the spirit and the scope of embodiments of the present application.

To avoid the defect that a traditional monitoring system needs manual duty and is easy to have omission, the applicant proposes a method for monitoring an abnormal behavior by adopting a convolutional neural network. To enable the convolutional neural network to identify a human pose, the applicant provides a method for training a convolutional neural network.

The CNN network obtained by training according to the training method of embodiments of the present disclosure can simultaneously identify multiple objects to be identified, and has a high calculation speed and low calculation complexity.

With the abnormal behavior monitoring method and abnormal behavior monitoring system provided by embodiments of the present disclosure, through constructing a human body skeleton map for an acquired image to be identified and identifying an abnormal behavior for the constructed human body skeleton map, once an abnormal behavior is detected, an alarm is immediately triggered. An abnormal behavior can be identified automatically and intelligently, and the identification is accurate, avoiding misjudgment and omission of manual monitoring, and reducing labor cost as well.

The methods are explained respectively in conjunction with embodiments.

### Embodiment One

The embodiment describes how to train and obtain a Deep Convolutional Neural Network (called a CNN network for short) for identifying a human pose. The CNN network in this embodiment obtains a skeleton map of key points of a human body though identifying an image to perform pose identification on one or more persons in the image.

The skeleton map of the key points of the human body is composed of a group of coordinate points, which are connected to describe a human pose. Each coordinate point in the skeleton map is called a key point (part, or portion or joint), and an effective connection between the two key points is called a limb (pair).

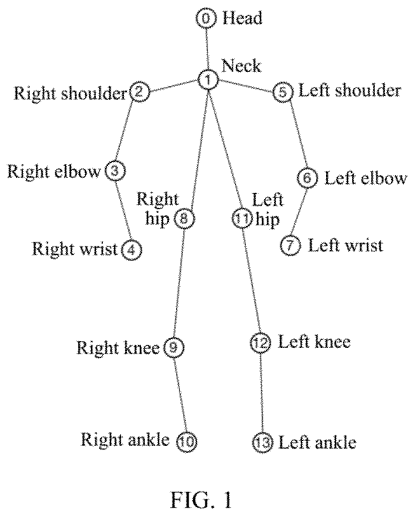

The identification of the key points of the human body described in this embodiment includes one or more of following identifications: an identification of the key points of a face, an identification of the key points of a body, an identification of the key points of feet, and an identification of the key points of hands. Herein, the identification of the key points of the face takes the face as an object, and a quantity of the key points may be selected from 6 to 130 depending on design accuracy and adopted database. The identification of the key points of the body takes a whole trunk part as an object. A complete skeleton map of the key points of the human body is shown in FIG. 1 and includes: 0—head, 1—neck, 2—right shoulder, 3—right elbow, 4—right wrist, 5—left shoulder, 6—left elbow, 7—left wrist, 8—right hip, 9—right knee, 10—right ankle, 11—left hip, 12—left knee and 13—left ankle. The identification of the key points of the hands takes the hands as an object, which may include identification of 21 key points of the hands. The identification of the key points of the feet takes the feet as an object, and a quantity of the key points is determined as required. An identification which contains all of the identification of the key points of the face, the identification of the key points of the body, the identification of the key points of the feet and the identification of the key points of the hands is an identification of key points of a whole body, which takes the face, the body, the feet and the hands as an identification object. According to different application scenarios, only part of the identifications may be performed during training. For example, when the present application is applied to an identification of an abnormal behavior, only the identification of the key points of the body may be performed, or the identification of the key points of the body and the identification of the key points of the face may be performed, or the identification of the key points of the body, the identification of the key points of the face and the identification of the key points of the hands may be performed, or the identification of the key points of the whole body may be performed. This embodiment will be described with the identification of the key points of the whole body as an example.

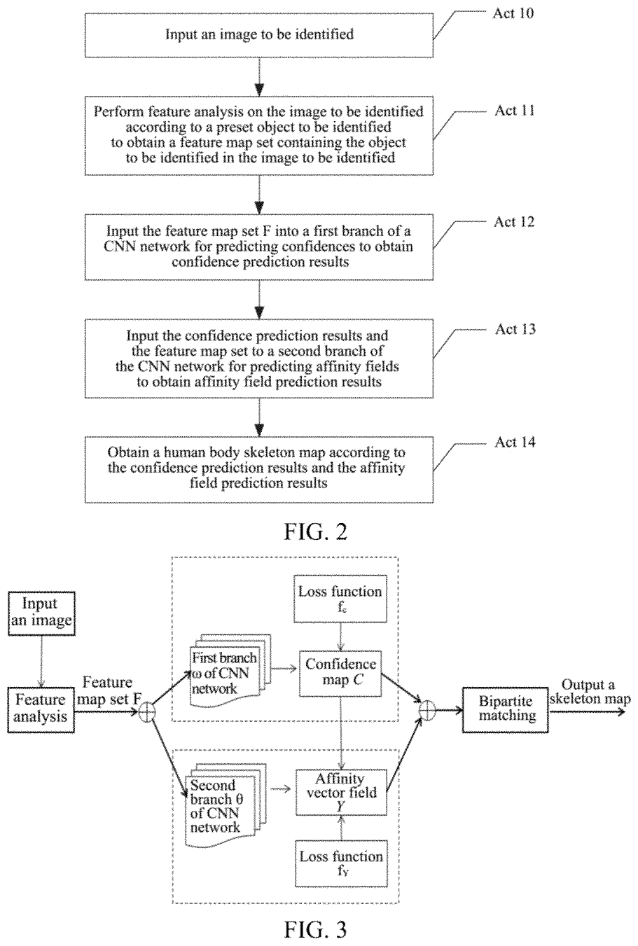

As shown in FIG. 2, the training method of the CNN network in this embodiment includes following acts 10, 11, 12, 13 and 14.

In act 10, an image to be identified is input.

The image to be identified may be acquired from an image capturing device, for example, the image to be identified may be an image directly captured by the image capturing device, or an image from a video captured by the image capturing device. In addition to acquiring the image to be identified from the image capturing device, the image to be identified may be acquired from a storage device storing an image or a video. Embodiments of the present disclosure do not limit the image capturing device for capturing an image, and any image capturing device may be used as long as it can capture an image. The image may be colored. There may be a single person or multiple persons in the image.

In act 11, according to a preset object to be identified, feature analysis is performed on the image to be identified to obtain one or more feature map sets containing an object to be identified in the image to be identified.

Taking the identification of the key points of the whole body as an example, the object to be identified includes: a face, a body, feet and hands, and all faces, bodies, feet and heads are obtained from the image to be identified. This process may also be referred to as a pre-training process.

For example, first 10 layers of VGG-19 may be used to perform feature analysis (e.g., initialization and fine tuning) on an input image to be identified to generate one or more feature map sets, and each feature map set F corresponds to one object to be identified. One feature map set contains one or more feature maps. For example, after feature analysis is performed on the image to be identified, four feature map sets may be obtained, including: a feature map set of a face, a feature map set of a body, a feature map set of feet and a feature map set of hands. Each feature map set includes all feature maps of the corresponding object to be identified in the image, for example, the feature map set of the face includes all face feature maps for the image, and the feature map set of the hands includes all hand feature maps for the image. In this example, using the first 10 layers of VGG-19 is merely an example. In another embodiment, a quantity of layers used may be different from that in this embodiment. Or, a network for extracting feature information to obtain the feature map set F may be another network.

In an exemplary embodiment, before feature maps are extracted from a part of a body, such as the face, the feet or the hands, a resolution of the image to be identified may be improved as required, so that at least two feature map sets in the obtained multiple feature map sets containing the objects to be identified in the image to be identified have different resolutions. For example, a resolution of a feature map obtained from the feature analysis on a part of the body is 128*128 ppi. However, if the resolution of 128*128 ppi is still adopted when the feature analysis is performed on the hands, local identification accuracy may be too low. Therefore, an original image may be enlarged to, for example, 960*960 ppi, and then the feature map of the hands may be extracted, to ensure the local identification accuracy. The resolutions of the feature maps of all objects to be identified may be different completely.

In act 12, one feature map set F is input into a first branch for predicting confidences to obtain confidence prediction results.

In this embodiment, a single-stage dual-branch CNN network is adopted to obtain a human body skeleton map, as shown in FIG. 3. A first branch is used to predict confidences (Part Confidence Maps), and a second branch is used to predict Part Affinity Fields (PAFs). The confidences are used to predict positions of key points, and the affinity fields are used to represent associations among the key points.

Specifically, one feature map set F is input into the first branch, and a training accuracy of the first branch is constrained by a preset confidence loss function. When the training accuracy satisfies the preset confidence loss function threshold, a confidence C=ω(F) may be obtained, where ω( ) corresponds to a network parameter of the first branch.

In this embodiment, the feature map sets of all the objects to be identified are predicted and trained at the same time, i.e., multi-task coexists, so that a skeleton map of a whole body can be predicted simultaneously in an actual network application, and a prediction speed is improved. In addition, since multi-task training and prediction are performed, prediction results will not be affected when a part of the human body is blocked, for example, when a body is blocked, the identification of the key points of the face and the hands will not be affected. When skeleton maps of multiple persons are identified, an algorithm complexity is greatly reduced, a calculation speed is improved, and calculation time is reduced.

The confidence loss function f_{c} may be calculated and obtained by the following formula:

$${f}_{C} = {\sum }_{j = 1}^{J} {\sum }_{p} R ( p ) \cdot {‖ {C}_{j} ( p ) - {C}_{j}^{*} ( p ) ‖}_{2}^{2} \qquad ( 1 )$$

In the formula, f_{c} is a confidence loss function, j represents a key point, j∈(1, . . . , J}, J is a total quantity of the key points; Cⱼ(p) is a confidence prediction value of the key point j at a coordinate position p of the image, Cⱼ*(p) is a real confidence of the key point j at p, or is a human joint point in a real state; R( ) is a function which is either 0 or 1, and when there is no label at p in the image, then R(p)=0. The function R is used to avoid punishing real positive prediction during training.

In act 13, the confidence prediction results and the one feature map set are input to a second branch for predicting affinity fields to obtain affinity field prediction results.

In this embodiment, the identification of the key points of the whole body is performed, and the confidence prediction results are a series set including 4 subsets, namely, a subset of the key points of the face, a subset of the key points of the body, a subset of the key points of the feet and a subset of the key points of the hands (the order is not limited). In another embodiment, a quantity of subsets in the series set may be different depending on different identified objects. Each subset has a key point(s) coincident with one or more other subsets so as to obtain a complete skeleton map of the whole body subsequently. For example, a coordinate of at least one key point in the subset of the key points of the face coincides with a coordinate of at least one key point in the subset of the key points of the body, a coordinate of at least one key point in the subset of the key points of the body coincides with a coordinate of at least one key point in the subset of the key points of the feet, and a coordinate of at least one key point in the subset of the key points of the body coincides with a coordinate of at least one key point in the subset of the key points of the hands. Each subset is taken as a unit to calculate affinity fields.

Specifically, one feature map set F and the confidence prediction results are input into the second branch, and a training accuracy is controlled by a corresponding preset affinity field loss function. When the training accuracy satisfies the preset affinity field loss function threshold, an affinity field Y=θ(F) may be obtained, where θ( ) corresponds to a network parameter of the second branch.

Since multi-task coexistence is adopted, when a resolution of a feature map of a part of a body is improved, to ensure the detection accuracy, a quantity of convolutional blocks in the second branch may be increased, for example, 10 convolutional blocks are set in the second branch, or the quantity of the convolutional blocks may be correspondingly increased or decreased according to a calculation speed. The quantity of the convolutional blocks in the second branch may be greater than the quantity of the convolutional blocks in the first branch.

In an exemplary implementation, to improve an overall accuracy, a width of a convolutional block or widths of multiple convolutional blocks in the second branch may be increased, wherein the widths of various convolutional blocks may be the same or different. For example, there are totally x convolutional blocks arranged in sequence. The width of each of the last h convolutional blocks may be set to be greater than the width of each of the previous x-h convolutional blocks, where x and h are both positive integers greater than 1, and h<x. For example, the width of the previous some convolutional blocks is 3*3, then the width of the last convolutional block may be set to 7*7, or 9*9, or 12*12, etc. The convolutional blocks of the first branch and the second branch may have different widths.

In an exemplary embodiment, when the quantity of the convolutional blocks is increased and the width(s) of the convolutional block(s) is increased, the quantity of network layers of the entire second branch may be reduced to 10 to 15 layers to ensure a prediction speed of the network.

The affinity field loss function f_{Y} may be calculated and obtained by the following formula:

$${f}_{Y} = {\sum }_{i = 1}^{I} {\sum }_{p} R ( p ) \cdot {‖ {Y}_{i} ( p ) - {Y}_{i}^{*} ( p ) ‖}_{2}^{2} \qquad ( 2 )$$

In the formula, f_{Y} is the affinity field loss function, i represents an affinity field, i∈{1, . . . , I}. I is a total quantity of the affinity fields; Yᵢ(p) is a prediction value of the i^{th} affinity field at p of the image, Yᵢ*(p) is a real value of the i^{th} affinity field at p, that is, a relationship between key points in a real state. R( ) is a function which is either 0 or 1, and when there is no label at p in the image, then R(p)=0. The function R is used to avoid punishing real positive prediction during training.

In an exemplary embodiment, after the confidence loss function is obtained in the above act 12 and the affinity field loss function value is obtained in act 13, a total target loss function may further be calculated, and whether a target loss function threshold is satisfied may be determined, to comprehensively evaluate accuracy of the prediction results of the network. When the preset confidence loss function threshold, the preset part affinity vector field loss function threshold and the preset target loss function threshold are all satisfied, training of the deep convolutional neural network is completed.

In act 14, a human body skeleton map is obtained according to the confidence prediction results and the affinity field prediction results.

With the affinity field approach, associations among the various key points may be detected, and position and rotation information in a whole limb region may be retained. The affinity field is a two-dimensional vector field of each limb. A two-dimensional vector code of each pixel belonging to a specific limb region is a vector pointing from one key point of the limb to another. In an exemplary embodiment, during training and testing, whether a connection is good or bad may be evaluated by calculating a linear integral of the corresponding affinity field. For a sum of positions of two possible key points, reliability of a line segment between the two points is evaluated by an integral value.

Assuming that the number of real confidence results is a, and the number of confidence prediction results obtained through the first branch of the CNN network is a+b, then in combine with the affinity fields, a confidence prediction results are selected from the a+b confidence prediction results and connected to form the skeleton map of the whole body.

When the affinity fields are calculated, Bipartite matching algorithm may be used for the calculation. In this embodiment, to improve the calculation speed and simplify calculation complexity, a greedy algorithm is introduced into the Bipartite matching algorithm to obtain the human body skeleton map.

In embodiments of the present disclosure, both the first branch and the second branch only need one stage to obtain good prediction results, without the need of performing multi-stage prediction.

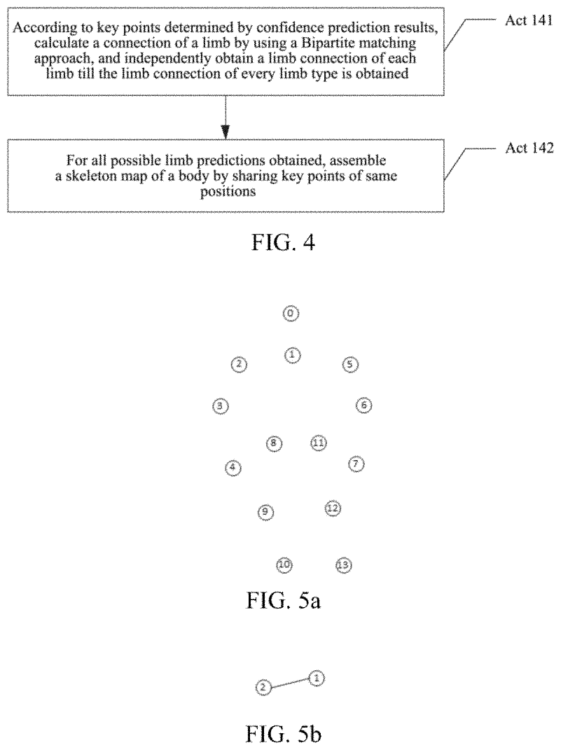

As each subset is used as a unit to calculate the affinity fields, taking calculation of the affinity fields of the body as an example, the Bipartite matching algorithm in which the greedy algorithm is introduced adopted in the above act 14 will be explained below. A process of calculating and obtaining the human body skeleton map is shown in FIG. 4, including following acts 141 and 142.

In act 141, the positions of the key points are determined according to the confidence prediction results, the connection of a limb is calculated according to the key points by using the Bipartite matching approach, and a limb connection of each limb (each limb type) is obtained independently till the limb connection of every limb type is obtained. A detection candidate set of all parts of the body in the image, namely the aforementioned series set, is obtained. Only a connection of adjacent nodes is considered, and only one limb connection is considered at one time. That is, for two key points connecting a limb 1, either key point has one subset, and two subsets m and n are obtained, the key points in m and the key points in n are matched respectively, and finally an affinity field of two related key points is calculated, and two key points with the strongest affinity field are selected to be connected to obtain a limb connection between the two key points. Using the Bipartite matching approach may increase the calculation speed, while in other embodiments, other algorithms may be used.

FIG. 5a is a schematic diagram of key points of a body obtained after the processing of the first branch, and FIG. 5b shows a connection between key point 1 and key point 2 obtained by calculation.

In act 142, the key points of the body are connected, and for all possible limb predictions obtained, the skeleton map of the body is assembled by sharing the key points of the same position, and the skeleton map of the body in this example is as shown in FIG. 5c.

For each object to be identified (i.e. each part of a body), the skeleton map of the object may be obtained by the above approach, and then all local skeleton maps are combined according to coincident key point coordinates (i.e., the key points of the same position are shared) to obtain the skeleton map of the whole body.

If the resolution of a feature map of a certain part of a body is increased when it is input into the CNN network, then image sizes need to be unified before the assembling.

The CNN network obtained by training according to the method of embodiments of the present disclosure can simultaneously identify multiple objects to be identified, and has a high calculation speed and low calculation complexity.

After the single-stage dual-branch CNN network is obtained by training according to the above method, during an actual usage, the human body skeleton map may be constructed by following acts, i.e., an algorithm for constructing the skeleton map includes following acts 21 and 22.

In act 21, an image to be identified is input into the CNN network obtained by training in the aforementioned embodiment.

In the algorithm, a colored image may be input.

In act 22, skeleton maps of all persons in the image are calculated and output through the CNN network.

Using the above CNN network to output human body skeleton maps has low complexity and high calculation speed.

### Embodiment Two

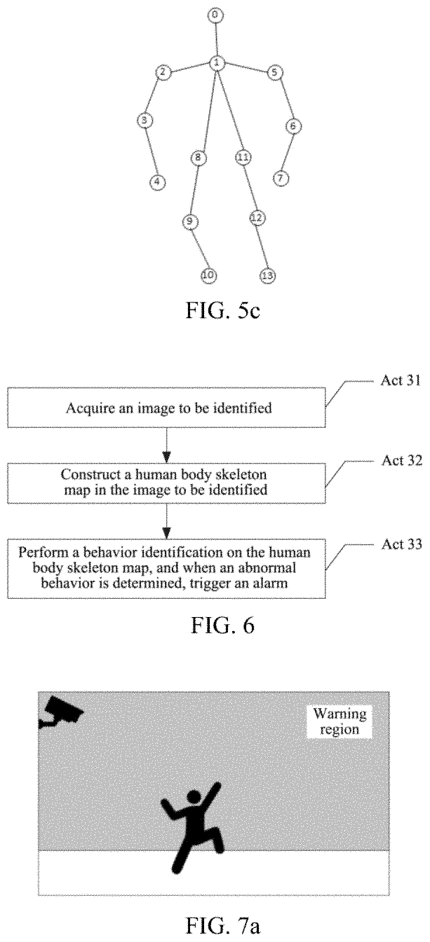

The CNN network obtained by training in the method of the above Embodiment one may be applied to monitor an abnormal behavior. FIG. 6 is a flow chart of an abnormal behavior monitoring method according to an embodiment of the present disclosure, including following acts 31-33.

In act 31, an image to be identified is acquired.

In this act, the image to be identified may be acquired from an image capturing device, for example, the image to be identified may be an image directly captured by the image capturing device, or an image from a video captured by the image capturing device. In addition to acquiring the image to be identified from the image capturing device, the image to be identified may be acquired from a storage device storing an image or a video. The image may be colored or black-and-white.

Embodiments of the present disclosure do not limit the image capturing device for capturing the image, and any image capturing device may be used as long as it can capture an image.

In act 32, a skeleton map of a human body in the image to be identified is constructed.

There may be one or more persons in the image to be identified, i.e., a skeleton map of a single person or skeleton maps of multiple persons may be constructed, and a pose of a human body may be relatively accurately depicted through the skeleton map, thus providing a basis for subsequent abnormal behavior identification. Specifically, the CNN network obtained by training according to Embodiment one may be used for multi-person pose estimation. First, the confidences and the affinity fields may be obtained through the trained CNN network; and then the Bipartite matching algorithm in which the greedy algorithm is introduced may be used to analyze the confidences and the affinity fields, and finally the skeleton maps of multiple persons are obtained.

In act 33, a behavior identification is performed for the skeleton map of the human body, and an alarm is triggered when an abnormal behavior is determined.

The abnormal behavior may be, for example, a preset insecure action. Insecure actions may be defined according to scenarios to which the monitoring method is applied. For example, when the monitoring method is applied to a balcony scenario, the insecure action may include but not limited to one or more of following actions: climbing, climbing up, breaking in, falling, etc. An action library may be preset for defining an abnormal behavior or for real-time identification of a human body skeleton map. When an abnormal behavior condition is satisfied, i.e., an abnormal behavior (e.g. an insecure action) feature is conformed with, an alarm is given.

In the abnormal behavior monitoring method provided by embodiments of the present disclosure, through constructing a human body skeleton map for an acquired image to be identified and identifying an abnormal behavior (e.g. an insecure action) for the constructed human body skeleton map, once an abnormal behavior is detected, an alarm is immediately triggered. An abnormal behavior can be identified automatically and intelligently, and the identification is accurate, avoiding misjudgment and omission of manual monitoring, and reducing labor cost as well.

Embodiments of the present disclosure are applicable to various security monitoring scenarios. For different security monitoring scenarios, it is only needed to set up corresponding abnormal behavior action libraries. For example, the embodiments of the present disclosure may be applied to a workplace such as a factory or an office building, or to a home scenario.

In an exemplary embodiment, taking balcony abnormal behavior monitoring as an example, to determine whether an action is secure, an insecure action(s) needs to be defined first.

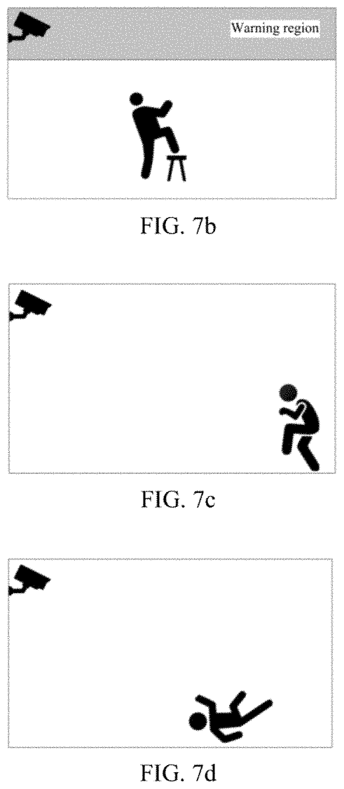

Here, in this embodiment, four types of actions are defined as insecure actions, namely climbing (FIG. 7a), climbing up (FIG. 7b), breaking in (FIG. 7c) and falling (FIG. 7d).

A climbing behavior and a climbing up behavior are the same type of climbing action, and determined from two perspectives. For example, when a person's foot exceeds a certain height (e.g. 0.3 meters), it is considered that the climbing behavior occurs and then an alarm is triggered. The climbing up behavior may refer to that when a person's head appears at a place higher than a normal height of a common person, such as 2 meters, it is considered that the climbing up behavior occurs and an alarm is triggered. In a sense, the two behaviors may coincide, or may not coincide. For example, when a child climbs to a certain height above 0.3 meters and below 2 meters, the climbing behavior will be triggered, but the climbing up behavior will not be triggered. If an adult climbs to a certain height, but a camera does not detect this person's foot due to obstruction of clothing or other things, but detects a head in a region above 2 meters, a climbing up event will be triggered instead of a climbing event. If the foot is above 0.3 meters and the head is in a space above 2 meters when climbing, both the climbing event and the climbing up event will be triggered, causing an alarm.

(a) Climbing Behavior

In a balcony monitoring picture, if someone climbs a railing, window, etc., an early warning of the climbing event may be popped up on a mobile phone. A schematic diagram of climbing is shown in FIG. 7a.

In an example, an action of both feet being off the ground and the body pose being climbing up may be defined as the climbing action. A rule set for this action may be that a region, at a direction near outdoor of the balcony, from at a certain height (e.g., 0.3 meters, which may be set by the user) from the ground to a ceiling is set as a warning region, and if it is determined that a leg appears in this region, the action is determined as a climbing action. This type of alarm usually does not have misjudgment.

(b) Climbing Up Behavior

In the balcony monitoring picture, if someone appears in a height range higher than that of a common person, an early warning of climbing up may be popped up on a mobile phone. A schematic diagram of climbing up is shown in FIG. 7b.

Within a height range set by a system, if a human head appears, it is defined as climbing up. The setting of this action may be, for example, a region on the balcony from a height beyond that of a normal person (for example, 2 meters, which may be set by the user) to a roof is set as a warning region, and if key points of a head of a person or a skeleton map of a face is detected within the warning region, an early warning is triggered. The climbing up event is a comprehensive identification of a skeleton feature and a pose of a human body, and there is usually no misjudgment in this type of action alarm.

(c) Breaking in Behavior

If someone is detected to break into the monitoring picture, an early warning of the breaking in behavior may be popped up on a mobile phone. A monitoring time period (or a protection time period) may be set as required. For example, when someone breaks in the balcony during sleeping time at night, then an alarm may be triggered (see FIG. 7c).

An event that someone is detected in the monitoring picture may be defined as a breaking in event. When a rule is set, an effective monitoring region (for example, the whole balcony region may be set as a monitoring region by default) and a protection time period may be set, and an alarm is triggered when someone breaks in within the time period. This type of alarm belongs to a type of skeleton identification, and them is usually no misjudgment.

(d) Falling Behavior

After a server starts an identification of a falling behavior of the camera, if someone is detected to suddenly faint or fall, etc., in the monitoring picture, an early warning picture of falling down may be popped up on a mobile phone screen.

From the perspective of a skeleton map, when a person's head, buttocks and feet are all in a same plane parallel to the ground, it is defined as a falling. When a rule is set for this action, it is not necessary to set the warning region or the protection time period, but the monitoring may be implemented in the whole region and in the whole time range. The user may adjust a sensitivity. The lower the sensitivity is, the higher the requirement of an identification rule is, and a misalarm may reduce. The higher the sensitivity is, the lower the requirement of an identification rule is, and the misalarm may increase. In addition, a threshold of falling time may be set, for example, when a person falls onto the ground, if he immediately gets up, no alarm will be given; if the person does not get up when the threshold of the falling time (for example, 2 minutes, which may be set by the user) is exceeded, an alarm will be given.

When the CNN network obtained by the training method of Embodiment one is applied to an abnormal behavior identification, especially to the identification of an abnormal behavior that has an impact on life security, a difference in a few seconds may cause different results. By using the CNN network, a result may be obtained quickly and time may be saved to the most extent.

### Embodiment Three

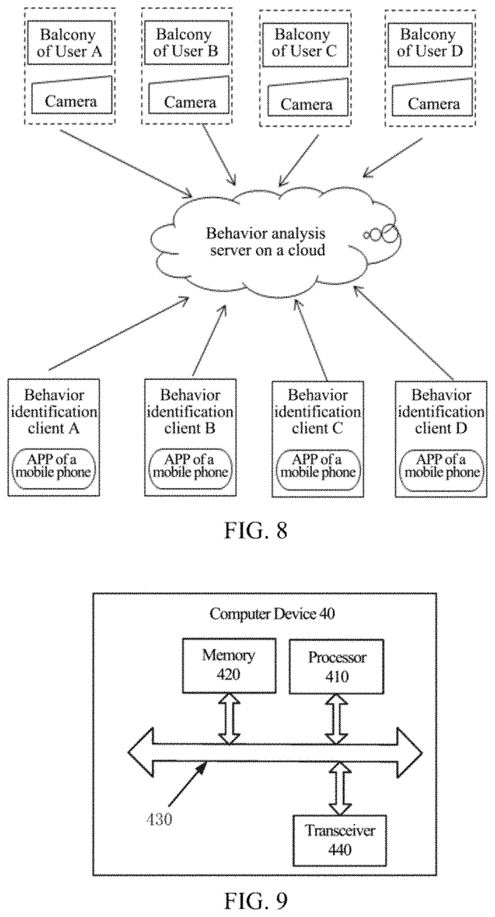

An embodiment of the present disclosure provides an abnormal behavior monitoring system based on a CNN network. When an abnormal behavior (such as an insecure behavior) appears in a monitoring region, a client will receive early warning information and a picture immediately. As shown in FIG. 8, a deployment of the system applied to a balcony scenario includes an image capturing apparatus, a server end and a client.

The image capturing apparatus is configured to capture an image to be identified.

The server end is configured to acquire the image to be identified sent by the image capturing apparatus, acquire a human body skeleton map for the image to be identified by using the CNN network, perform a behavior identification on the skeleton map, and send an alarm signal to the client when an abnormal behavior is determined.

The client is configured to receive an alarm signal sent by the server end, trigger an alarm according to the alarm signal, and if the alarm signal contains an early warning image, then display the early warning image in real time.

For example, when the monitoring system is a balcony security system, cameras may be installed on the balconies of multiple users, and these cameras may capture real-time videos of the balconies. The server end may receive the real-time videos sent by the cameras of the balconies of the multiple users and perform real-time analysis, and the server may be set in a cloud, and when the cloud server determines an abnormal behavior, it sends an alarm signal to a corresponding client. The client may be implemented by downloading a corresponding application program (APP) to a user's handheld terminal. The client may provide the user with the setting of one or more of following contents: an abnormal behavior which needs to be monitored (such as one or more of following behaviors: climbing up, climbing, breaking in and falling), an early warning region, a monitoring region, a monitoring time period, a monitoring sensitivity, etc.

The monitoring system of the abnormal behavior provided by embodiments of the present disclosure has main advantages of capable of fast and active defense and early warning. All kinds of abnormal behaviors to be identified are set by the user through the client in advance, and the user is warned for all kinds of abnormal behaviors identified by the system. Based on cloud computing and behavior identification and analysis capabilities, a problem that it is difficult to find an abnormal issue manually is solved. The system may further send on-site pictures of various emergencies to the user client, which is convenient for the user to handle and solve on-site issues. The system of this embodiment is not only applicable to a large public occasion, but also applicable to intelligent monitoring of home security.

The intelligent behavior identification of embodiments of the present disclosure is based on real-time multi-person human body pose identification. Given an RGB picture, position information of the key points of all persons may be obtained, and at the same time, which person in the picture each key point belongs to, that is, connection information between the key points, may be determined. A traditional multi-person sub-group estimation algorithm generally adopts a top-down mode. A first major defect of this mode is that detection of a human pose is relied on, and a second defect is that a speed of the algorithm is proportional to a quantity of persons in a picture. The system of the present disclosure adopts a bottom-up mode. Firstly, the key points of the human body are detected, then these key points are connected by calculating the affinity fields, and finally the skeleton map of the human body is drawn. In addition, compared with the traditional analysis method, the present disclosure detects each frame of images on the video in real time, and at the same time since the CNN network obtained by training can perform multiple tasks simultaneously, a response speed of this system to abnormal behavior event processing is much faster than that of the traditional method.

In an exemplary embodiment of the present application, a computer device is further provided. The device may include a processor, a memory, and a computer program stored on the memory and capable of running on the processor. When the processor executes the computer program, the processor implements the operations performed by the server device according to embodiments of the present disclosure.

As shown in FIG. 9, in an example, a computer device 40 may include a processor 410, a memory 420, a bus system 430, and a transceiver 440. The processor 410, the memory 420, and the transceiver 440 are connected through the bus system 430, the memory 420 is used for storing instructions, and the processor 410 is used for executing the instructions stored in the memory 420 to control the transceiver 440 to send a signal.

It should be understood that the processor 410 may be a Central Processing Unit (CPU), or the processor 410 may be another general purpose processor, a Digital Signal Processor (DSP), an Application Specific Integrated Circuit (ASIC), a Field Programmable Gate Array (FPGA) or another programmable logic device, a discrete gate or a transistor logic device, a discrete hardware component, etc. The general-purpose processor may be a microprocessor or the processor may be any conventional processor or the like.

The memory 420 may include a read only memory and a random access memory, and provides instructions and data to the processor 410. A portion of the memory 420 may include a nonvolatile random access memory.

The bus system 430 may include a power bus, a control bus, a status signal bus, or the like in addition to a data bus. However, for the sake of clarity, various buses are designated as the bus system 430 in FIG. 9.

In an implementation process, the processing performed by the computer device may be completed by an integrated logic circuit of hardware or instructions in the form of software in the processor 410. That is, the acts of the method disclosed in embodiments of the present disclosure may be embodied as the completion of execution by a hardware processor, or the completion of execution by a combination of hardware and software modules in the processor. The software modules may be located in a storage medium such as a random memory, a flash memory, a read-only memory, a programmable read-only memory or an electrically erasable programmable memory, a register, etc. The storage medium is located in the memory 420, and the processor 410 reads information in the memory 420 and completes the acts of the above method in combination with its hardware. To avoid repetition, it will not be described in detail here.

The above shows and describes the basic principles and main features of the present application and the advantages of the present application. The present application is not limited by the above embodiments. The above embodiments and the description in the specification only illustrate the principles of the present application. Without departing from the spirit and scope of the present application, the present application will have various changes and improvements, all of which fall within the scope of the present claimed application.

Those of ordinary skill in the art can understand that all or some of the acts in the method disclosed above, the functional modules/units in the apparatus and the system may be implemented as software, firmware, hardware, and an appropriate combination thereof. In a hardware implementation, division between the functional modules/units mentioned in the above description does not necessarily correspond to division of physical components; for example, a physical component may have multiple functions, or a function or an act may be performed by several physical components in cooperation. Some or all of the components may be implemented as software executed by a processor, such as a digital signal processor or a microprocessor, or as hardware, or as an integrated circuit, such as an application specific integrated circuit. Such software may be distributed on a computer readable medium, which may include a computer storage medium (or a non-transitory medium) and a communication medium (or a transitory medium). As is well known to those of ordinary skill in the art, the term computer storage medium includes a volatile and nonvolatile, removable and non-removable medium implemented in any method or technology for storing information (such as computer readable instructions, a data structure, a program module or other data). The computer storage medium includes, but is not limited to, a RAM, a ROM, an EEPROM, a flash memory or another memory technology, a CD-ROM, a digital versatile disk (DVD) or another optical disk storage, a magnetic cassette, a magnetic tape, a magnetic disk storage or another magnetic storage apparatus, or any other media which can be used to store expect information and can be accessed by a computer. Furthermore, it is well known to those of ordinary skill in the art that the communication medium usually contains computer readable instructions, a data structure, a program module, or other data in a modulated data signal such as a carrier wave or another transmission mechanism, and may include any information delivery medium.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A training method of a deep convolutional neural network, wherein the deep convolutional neural network is a single-stage dual-branch convolutional neural network and comprises a first branch for predicting confidences and a second branch for predicting part affinity vector fields, and the method comprises:
inputting an image to be identified;
according to one or more preset objects to be identified, performing feature analysis on the image to be identified to obtain one or more feature map sets for the one or more objects to be identified in the image to be identified, wherein each feature map set corresponds to one object to be identified;
inputting a feature map set into the first branch of the deep convolutional neural network to obtain confidence prediction results;
inputting the confidence prediction results and the feature map set into the second branch of the deep convolutional neural network to obtain affinity field prediction results.

2. The training method according to claim 1, wherein the method further comprises:
after obtaining the confidence prediction results at the first branch, calculating a confidence loss function, and determining whether a preset confidence loss function threshold is satisfied;
after obtaining the part affinity vector field prediction results at the second branch, calculating a part affinity vector field loss function, and determining whether a preset part affinity vector field loss function threshold is satisfied;
calculating a sum of the confidence loss function and the part affinity vector field loss function, and determining whether a preset target loss function threshold is satisfied;
when the preset confidence loss function threshold, the preset part affinity vector field loss function threshold, and the preset target loss function threshold are all satisfied, completing training of the deep convolutional neural network.

3. The training method according to claim 1, wherein before performing the feature analysis on the image to be identified, the method further comprises:
increasing a resolution of the image to be identified; wherein at least two feature map sets in the obtained feature map sets for objects to be identified in the image to be identified have different resolutions.

4. The training method according to claim 1, wherein,
a quantity of convolutional blocks in the second branch is larger than a quantity of convolutional blocks in the first branch.

5. The training method according to claim 1, wherein,
the second branch comprises x convolutional blocks arranged in sequence, a width of each of last h convolutional blocks in the second branch is greater than a width of each of previous x-h convolutional blocks, where x and h are positive integers greater than 1, and h<x.

6. A method for constructing a skeleton map based on a deep convolutional neural network, wherein the deep convolutional neural network is a single-stage dual-branch convolutional neural network and comprises a first branch for predicting confidences and a second branch for predicting part affinity vector fields, and the method comprises:
inputting an image to be identified into the deep convolutional neural network obtained by training according to the method of claim 1, to obtain confidence prediction results and affinity field prediction results; and
obtaining a skeleton map according to the confidence prediction results and the affinity field prediction results.

7. The method for constructing the skeleton map according to claim 6, wherein obtaining the skeleton map according to the confidence prediction results and the affinity field prediction results comprises:
for each object to be identified, obtaining positions of key points according to the confidence prediction results, calculating and obtaining a limb connection of each limb type by using a Bipartite matching approach according to the key points, and constructing a skeleton map of the object to be identified by sharing key points of same positions.

8. An abnormal behavior monitoring method based on a deep convolutional neural network, wherein the deep convolutional neural network is the deep convolutional neural network obtained by training according to the method of claim 1, and the method comprises:
acquiring an image to be identified;
acquiring a human body skeleton map for the image to be identified by using the depth convolutional neural network; and
performing a behavior identification on the skeleton map, and when an abnormal behavior is determined, triggering an alarm.

9. The abnormal behavior monitoring method according to claim 8, wherein the deep convolutional neural network is a single-stage dual-branch convolutional neural network and comprises a first branch for predicting confidences and a second branch for predicting part affinity vector fields, and acquiring the human body skeleton map for the image to be identified by using the depth convolutional neural network, comprises:
inputting an image to be identified;
according to one or more preset objects to be identified, performing feature analysis on the image to be identified to obtain one or more feature map sets for the one or more objects to be identified in the image to be identified, wherein each feature map set corresponds to one object to be identified;
inputting a feature map set into the first branch of the deep convolutional neural network to obtain confidence prediction results;
inputting the confidence prediction results and the feature map set into the second branch of the deep convolutional neural network to obtain affinity field prediction results; and
obtaining the human body skeleton map according to the confidence prediction results and the affinity field prediction results.

10. The abnormal behavior monitoring method according to claim 9, wherein before performing the feature analysis on the image to be identified, the method further comprises: increasing a resolution of the image to be identified; wherein at least two feature map sets in the obtained feature map sets for objects to be identified in the image to be identified have different resolutions.

11. The abnormal behavior monitoring method according to claim 9, wherein obtaining the human body skeleton map according to the confidence prediction results and the affinity field prediction results comprises:
for each object to be identified, obtaining positions of key points according to the confidence prediction results, calculating and obtaining a limb connection of each limb type by using a Bipartite matching approach according to the key points, and constructing a skeleton map of the object to be identified by sharing key points of same positions.

12. An abnormal behavior monitoring system based on a deep convolutional neural network, wherein the deep convolutional neural network is a deep convolutional neural network obtained by training according to the method of claim 1, and the system comprises:
an image capturing apparatus, configured to capture an image to be identified;
a server end, configured to acquire the image to be identified sent by the image capturing apparatus, acquire a human body skeleton map for the image to be identified by using the deep convolutional neural network, perform a behavior identification on the skeleton map, and when an abnormal behavior is determined, send an alarm signal to a client; and
the client, configured to receive the alarm signal sent by the server end and trigger an alarm according to the alarm signal.

13. A computer readable storage medium on which program instructions are stored, wherein when the program instructions are executed, the method according to claim 1 is implemented.

14. A computer readable storage medium on which program instructions are stored, wherein when the program instructions are executed, the method according to claim 6 is implemented.

15. A computer readable storage medium on which program instructions are stored, wherein when the program instructions are executed, the method according to claim 8 is implemented.

16. A computer device, comprising a memory, a processor and a computer program stored on the memory and executable by the processor, wherein the processor implements acts of the method according to claim 1 when executing the program.

17. A computer device, comprising a memory, a processor and a computer program stored on the memory and executable by the processor, wherein the processor implements acts of the method according to claim 6 when executing the program.

18. A computer device, comprising a memory, a processor and a computer program stored on the memory and executable by the processor, wherein the processor implements acts of the method according to claim 8 when executing the program.
